(19) United States
(12) Patent Application Publication
(10) Pub. No.: US 2016/0154555 A1
(43) Pub. Date: Jun. 2, 2016

(54) INITIATING APPLICATION AND PERFORMING FUNCTION BASED ON INPUT

(71) Applicant: Lenovo (Singapore) Pte. Ltd., New Tech Park (SG)

(72) Inventors: Steven Richard Perrin, Raleigh, NC (US); Jianbang Zhang, Raleigh, NC (US); John Weldon Nicholson, Cary, NC (US); Scott Edwards Kelso, Cary, NC (US)

(21) Appl. No.: 14/557,628

(22) Filed: Dec. 2, 2014

(51) Int. Cl. G06F 3/0484; G06F 3/0488; G06F 3/0482; G06F 17/30; G06F 3/0481

(52) U.S. Cl. CPC G06F 3/0484; G06F 17/30477; G06F 3/04817; G06F 3/0482; G06F 3/04842; G06F 3/04883

(57) ABSTRACT

In one aspect, a device includes a processor, a touch-enabled display accessible to the processor, and a memory accessible to the processor. The memory bears instructions executable by the processor to receive first input to the touch-enabled display at an area of the touch-enabled display which presents at least partially thereat an icon associated with a first application. The instructions are also executable to, in response to receipt of the first input, initiate the first application and execute a search at least in part based on the first input using the first application.

### FIELD

The present application relates generally to initiating an application at a device and providing data thereto.

### BACKGROUND

Typically, a user desiring to undertake an action using an application must first launch the application, ascertain where (or even if) in an application window feat is presented (here may he a feature useful to undertake the desired action, and then command the application to take the action accordingly using the feature. This process can he relatively time consuming, burdensome, and frustrating.

### SUMMARY

Accordingly, in one aspect a device includes a processor, a touch-enabled display accessible to the processor, and a memory accessible to the processor. The memory bears instructions executable by the processor to receive first input to the touch-enabled display at an area of the touch-enabled display which presents at least partially thereat an icon associated with a first application. The instructions are also executable to, in response to receipt of the first, input, initiate the first application and execute a search at least in part based on the first input using the first application.

In another aspect, a method includes receiving at least a portion of first input to a user interface (UI) presented on a touch-enabled display at an area of the UI associated with a first application that is different from a second application which is used to present the UI. The method also includes, in response to receiving the first input, launching the first application and providing data pertaining to the first input, to the first application for performing a function at least in part using the data. The function is a function that would not otherwise he performed upon launching the application without additional input from a user subsequent to launch.

In still another aspect, a computer readable storage medium that is not a carrier wave includes instructions executable by a processor to receive at least a portion of first input to a touch-enabled display accessible to the processor at a portion of the touch-enabled display associated with an application and, in response to receipt of the first input, initiate the application and provide data pertaining to the first input to the application for performance of a function at least in part using the data.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIGS. 3 and 4 are flow charts showing example algorithms in accordance with present principles; and

FIGS. 5-15 are example user Interfaces (UIs) in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network, such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general, purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can he written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

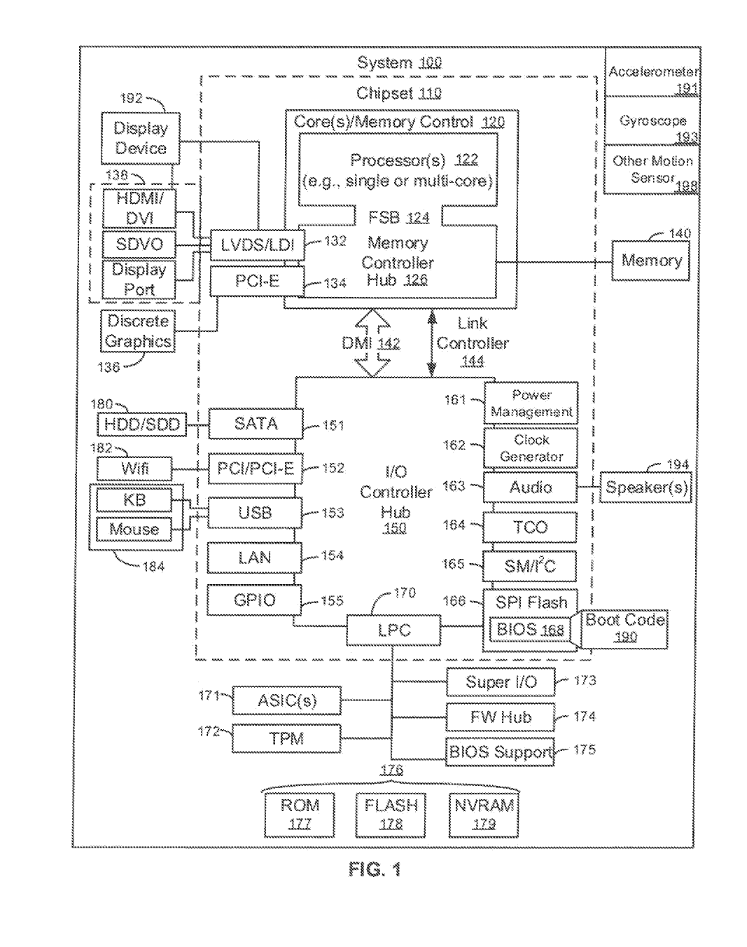

Now specifically in reference to FIG. 1, it shows an example block diagram of an information handling system and/or computer system 100. Note that in some embodiments the system 100 may be a desktop computer system, such as one of the ThinkCentre® or ThinkPad® aeries of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be e.g. a game console such as XBOX® or Playstation®.

As shown in FIG. 1, the system 100 includes a so-called chipset 110. A chipset refers to a group of integrated circuits, or chips, that are designed to work together. Chipsets are usually marketed as a single product, (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control, group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control, group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller huh 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132, The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including e.g. one of more CPUs). An example system may include AGP or PCI-E for support of graphics.

The I/O hub controller 150 includes a variety of interfaces. The example of FIG. 1 includes a SATA interface 151 one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction, of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interlace 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof but in any case the drives 180 are understood to be e.g. tangible computer readable storage mediums that may not be carrier waves. The I/O hub controller 150 may also include an advanced host controller interface (AHCI) to support one or more drives 180. The PCI-E interlace 152 allows for wireless connections 182 to devices, networks, etc. The USB interface 153 provides for input devices 184 such as keyboards (KB), mice and various other devices (e.g., cameras, phones, storage, media players, etc,).

In the example of FIG. 1, the LPC interlace 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may fee configured to execute boot code 190 for the BIOS 168, as stored within the SPI Flash 166, and thereafter processes data under the control of one or more operating systems and application software (e.g., stored in system memory 140). An operating system may he stored in any of a variety of locations and accessed, for example, according to instructions of the BIOS 168.

Still in reference to FIG. 1, the system 100 also includes an accelerometer 191 for e.g. sensing acceleration and/or movement of the system 100, along with a gyroscope 193 for e.g. sensing and/or measuring motion and/or the orientation of the system 100 and optionally another motion sensor 198 that is also for sensing motion of the system 100.

Though now shown for clarity, in some embodiments the system 100 may include an audio receiver/microphone providing input to the processor 122 e.g. based on a user providing audible input to the microphone, and a camera for gathering one or more images and providing input, related thereto to the processor 122. The camera may be, e.g., a thermal imaging camera, a digital camera such as a webcam, and/or a camera integrated into the system 100 and controllable by the processor 122 to gather pictures/images and/or video. Still further, and also not shown, for clarity, the system 100 may include a GPS transceiver that is configured to e.g. receive geographic position information from at least one satellite and provide the information to the processor 122. However, it is to be understood that another suitable position receiver other than a GPS receiver may be used in accordance with present principles to e.g. determine the location of the system 100.

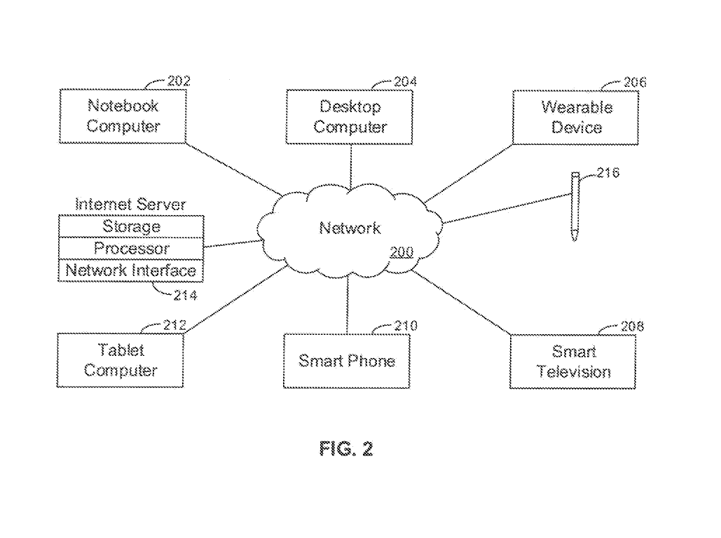

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that e.g. each of the devices described In reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 210, a tablet computer 212, at least one input device 216 (e.g. a stylus and/or electronic pen configured for providing input (e.g. touch and/or hover input) to a touch-enabled display and/or touch-enabled pad, and a server 214 such as e.g. an Internet server that may e.g. provide cloud storage accessible to the devices 202-212, and 216. Furthermore, it is to be understood that the devices 202-216 are configured to communicate with each other over the network 200 to undertake present principles.

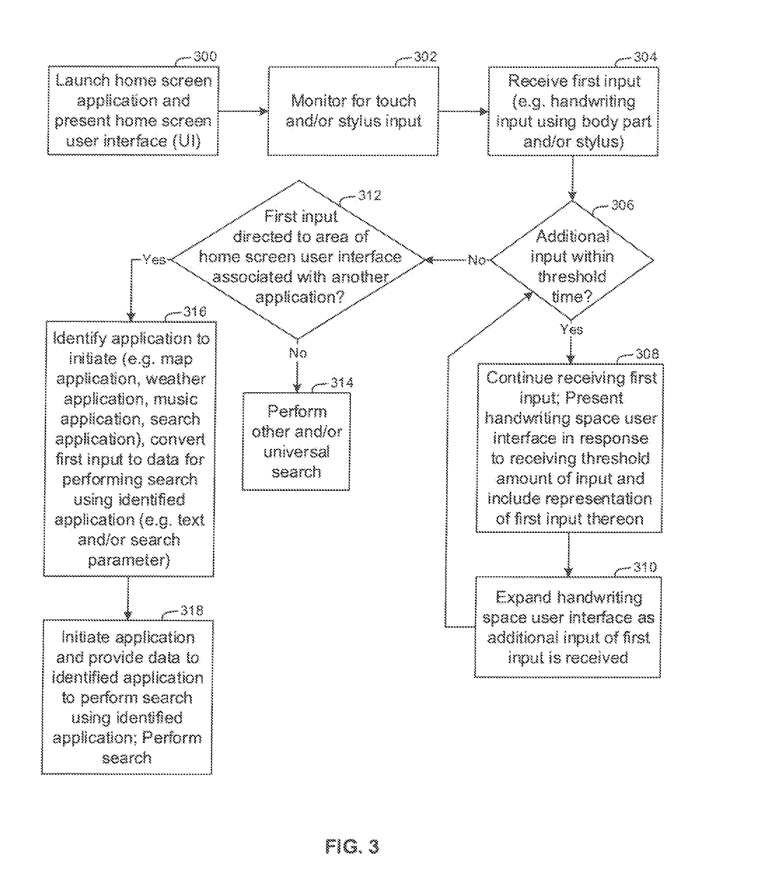

Referring to FIG. 3, it shows example logic that may be undertaken by a device such as the system 100 in accordance with present principles. Beginning at block 300, the logic launches and/or initiates a desktop application and/or home screen application (referred to below as a “home screen application” for simplicity) and presents a user interface (UI) associated therewith. The home screen UI may be e.g. the default UI presented upon powering on the device and may present e.g. one or more icons, tiles, and/or other area and selector elements that are selectable to initiate other applications (e.g. besides the home screen application) stored on the system 100, as well as e.g. widgets. After block 300, the logic proceeds to block 302 where the logic monitors for touch and/or stylus input to the home screen UI, such as e.g. to select an icon presented on the home screen UI to launch an application associated therewith, and/or to receive other input such as the first input received at block 304 which may be e.g. handwriting input using a body part and/or stylus to the home screen UI. Such handwriting input to establish the first input received at block 304 may in some embodiments be, relative to a plane established by a face of the touch-enabled display to which the first input is directed and on which images are presentable, input other than laterally unmoving touch input.

Thus, upon receiving the first input at block 304 which may be e.g. handwriting input using a stylus, the logic proceeds to decision diamond 306. At diamond 306 the logic determines whether additional input beyond that received at block 304 has been received within a threshold time, where the threshold time may fee specified by a user of the system 100 e.g. using a settings UI such as the one to be described in reference to FIG. 15.

An affirmative determination at diamond 306 causes the logic to proceed to block 308, where the logic continues receiving additional input of the first input and presents a UI for a user to direct the additional input thereto and to represent the first input received to that point (such a UI will be referred to below as a “handwriting space UI” for simplicity). In some embodiments, the handwriting space UI may be presented in response to receiving a threshold amount of input. After block 308 the logic moves to block 310 where the logic may, as more of the first input is received (e.g. within the threshold time) expand the handwriting space UI as the additional first input is received to thus encompass the expanding area to which the first input is being directed as the first input is provided. After block 310, the logic may revert back to diamond 306 and proceed therefrom.

Once the logic determines at diamond 306 that additional input has not been received for and/or within a threshold time, the logic moves to decision diamond 312. At diamond 312 the logic determines whether the first input received at blocks 304, 308, and/or 310 has been directed to an area of the home screen UI that is associated with an application. For instance, the logic may determine whether the first input has been directed to at least a portion of the touch-enabled display presenting an icon associated with an application, a tile or other selector element associated with an application, and/or an area of the UI otherwise associated with the application (e.g. one at which an “invisible” widget is presented that, though, not visible to a user even though the user may be aware of its presence, may receive handwriting input thereto (e.g. using a body party or stylus) for undertaking present principles). In any case, a negative determination at diamond 312 causes the logic to move to block 314, where the logic may, based on the first input that has been received, e.g. convert the first input to data such as e.g. textual data that may then be used to execute a search for information regardless of application, such as e.g. a “universal” search of e.g. data stored locally on the system 100, and/or an Internet and/or a cloud storage search.

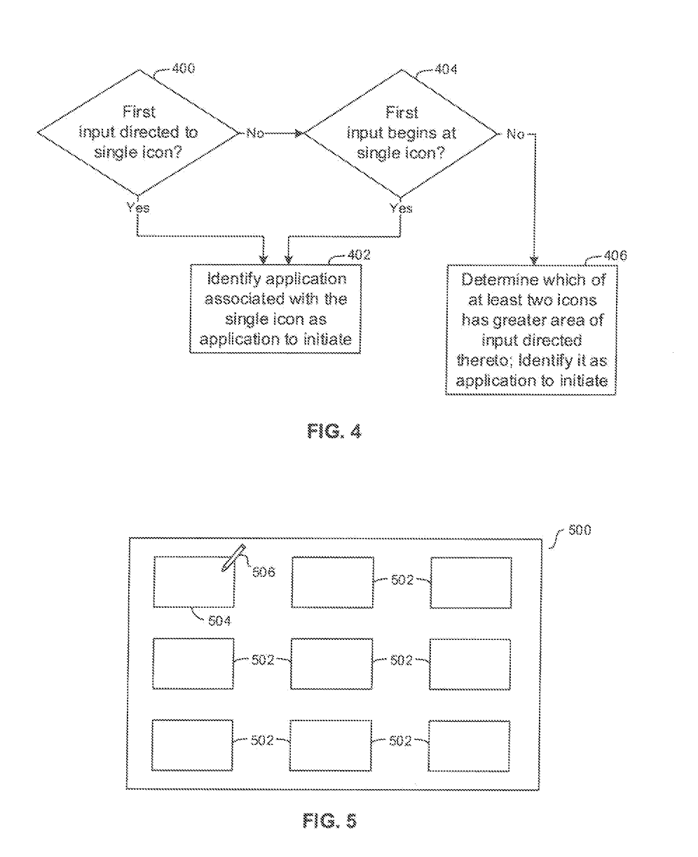

Note, however, that if instead an affirmative determination is made at diamond 312, the logic instead proceeds to block 316 from diamond 312. At diamond 316 the logic identifies an application to initiate and/or launch (e.g. a map application, a weather application, a music player application, or a search application) based on the area of the home screen UI to which at least a portion of the first input was directed. The identification of an application to initiate will he discussed further in reference to FIG. 4. Still in reference to block 316, also thereat the logic converts the first input that was received to data and/or at least one parameter for performing a search based on the data using the identified application.

After block 316 the logic proceeds to block 318 where the logic initiates the identified application and provides the data and/or parameter to the identified application to perform a search using the identified application. Also at block 318, the logic performs a search accordingly using the identified application.

Before describing FIG. 4, note that at least some of the steps described, above may be performed using the home screen application, such as e.g. receiving the first input, processing the first input, and providing the data associated therewith to the identified application for execution of the search. Also, it is to be understood that in example embodiments, the search using the identified application is a function that would not otherwise be performed upon launching the identified application without additional input from a user subsequent to launch such as e.g. to use a user Interface of the identified and launched application to at that point perform the search. Note farther that present principles are understood to apply when the function to execute based on the first input to the home screen UI is not to perform a search hut rather e.g. to navigate to or otherwise cause a specific feature (e.g. a UI) of the identified application to be presented that would not otherwise be presented upon launch of the identified application, to configure settings for the identified application using a settings UI associated therewith, to configure an alarm to be set (e.g. if the identified application is a clock and/or alarm application) based on the first input (e.g. if the first input was “8:30 p.m.), to create a calendar entry for an electronic calendar based on the first input, etc. Which of such example functions is the function to execute may be based on e.g. user input (e.g. to a settings UI such as the one to be described below in reference to FIG. 15), and may vary based on the particular application (e.g. also based on user input).

In any case, in embodiments where the function is to execute a search based on the first input, examples of search types include the following: for a map application (e.g., Google Maps), performing a search for a location and/or for directions to the location; for a weather application, performing a search for weather at a location indicated in the first input; for a music player and/or purchasing application, performing a search for e.g. an artist, song, or album indicated in the first application; and for an Internet search application (e.g. a Google application), performing an Internet search based on a parameter identified by the logic from the first input.

Continuing the detailed description in reference to FIG. 4, it shows example logic that may he undertaken by a device such as the system 100 to identify an application to initiate and provide data thereto for e.g. execution of a search in accordance with present principles. The logic begins at decision diamond 400, which may, in some embodiments, be arrived at while undertaking what has been described above in reference to block 316 and/or responsive to an affirmative determination at diamond 312. Regardless, at diamond 400 the logic determines whether the first input that has been received (e.g. at blocks 304, 308, and/or 310 as described above) has been directed to an area (e.g. an icon) of the home screen UI associated with one application e.g. other than the home screen application, even if e.g. some of the first input is also directed to “empty space” not presenting an area associated with an application other than the home screen application.

An affirmative determination at diamond 400 causes the logic to proceed block 402, where the logic identifies an application associated with the area to which the first input was directed. However, a negative determination at diamond 400 instead causes the logic to move to decision diamond 404, where the logic determines whether the first input began at an area (e.g. an icon) of fee home screen UI associated with one application e.g. other than the home screen application itself, even if e.g. some of the first input is also directed to “empty space” not presenting an area associated with an application other than the home screen application. Such a “beginning” of the first input may be e.g. the location at the home screen UI that was initially contacted when providing the first input.

An affirmative determination at diamond 404 causes the logic to proceed to block 402, where the logic identifies an application associated with the area at which the first input, in this case, began. However, a negative determination, at diamond 404 instead causes the logic to proceed to block 406 where the logic determines which of at least two areas associated with different respective applications other than the home screen application (e.g. icons presented on the home screen UI selectable to launch other applications at the system 100) to which the first input has been directed is the area to which a greater amount of the first input was directed. The application associated with the area to which the greater amount of the first input was directed is thus identified, also at block 406, as the application to initiate and provide data associated with the first input in accordance with present principles.

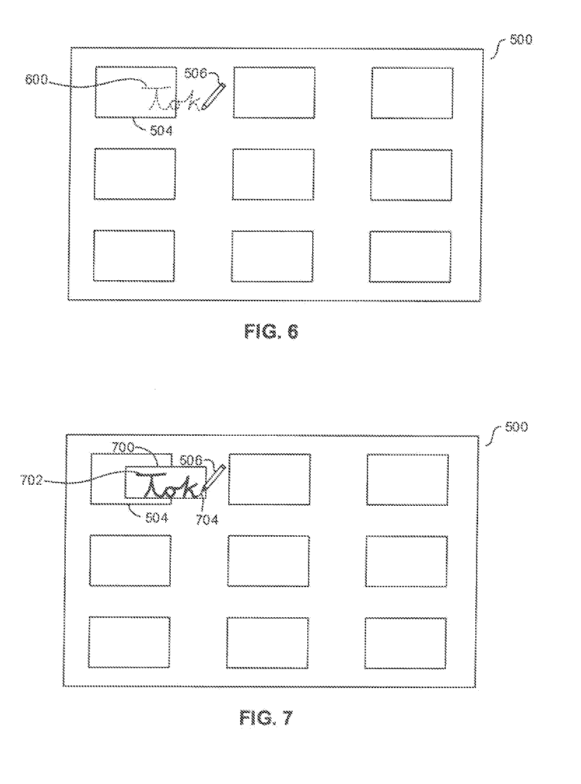

Reference is now made to FIG. 5, which shows an example home screen UI 500 with plural icons 502 presented thereon. Also note that one of the icons 502, labeled icon 504, is a portion of an area to which input has begun to he provided based on contact of the example stylus 506 with the icon 504. As may be appreciated from FIG. 6, the UI 500 has had at least a portion of input directed thereto, as represented by the example tracing 600 (e.g. perforated lines) shown on FIG. 6. It may be appreciated from FIG. 6 that the first input as represented by the tracing 600 includes handwritten characters for the letters “Tok”.

Referring to FIG. 7, the UI 500 has had a handwriting space UI 700 overlaid thereon, which may have been presented responsive to receiving a threshold amount of the input, within a threshold time of receiving the beginning of the first input, immediately upon receiving the beginning of the first input, based on a command from a user (e.g. audible command, a button press, identification of the user looking at a particular (e.g. empty) area of the home screen, etc.) etc. Note that the UI 700 includes thereon a representation 702 of the handwritten characters for the letters “Tok” as received based on the input. Furthermore, note that a perforated portion 704 as shown is understood to not form part of the representation 702 but instead represents additional input that has been received in addition to the handwritten characters for the letters “Tok”. Notwithstanding, it is to be further understood that upon receipt of such input, the input illustrated, as portion 704 may be represented on the UI 700 as pan of the representation 702.

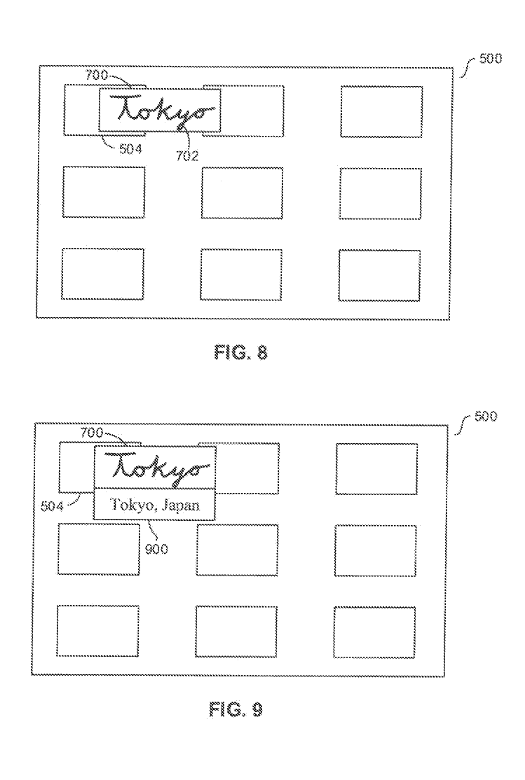

Thus, as shown in FIG. 8, the UI 700 has expanded in area relative to the area of the UI 500 if occupied and/or was overlaid on as shown in FIG. 7. As also shown in FIG. 8, the UI 700 includes a representation not only of the handwritten diameters for the letters “Tok” but for the additional handwritten characters for the letters “yo” thus together representing the handwritten characters tor the letters “Tokyo”, owing to additional input (e.g. of the “first Input” as described herein) being received after the moment the UI 700 as represented in FIG. 7 was presented. Then, as shown in FIG. 9, based on the input that has been provided to that point (e.g. the handwritten characters for the letters “Tokyo”, at least one recommendation 900 may be presented (e.g. in typeface text as shown, though in other embodiments it may be presented in a graphical representation of the user's handwriting as used to provide the input) for a parameter that matches the handwriting input (e.g. based on converting the handwriting input to data (e.g. text)). In some embodiments, the one or more recommendations that are provided may include e.g. (and sometimes only comprise) context-relevant recommendations based on an application identified as the application to which the input has been directed. Thus, e.g. assume that the icon 504 is associated with a weather application, Recommendations tor the weather application in accordance with present principles would, include parameters (e.g. in this case, locations) such as e.g. cities, states, countries, etc, but not a recommendation for a motion picture such as “Tokyo Drift” based on the application being configured to search and/or otherwise process parameters for locations to ascertain weather conditions.

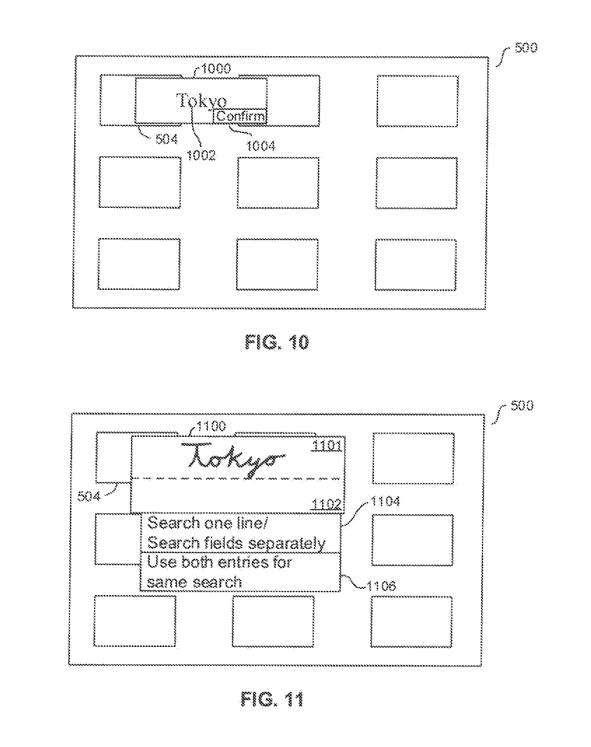

FIG. 10 shows another example embodiment of a handwriting space UI 1000, but rather than presenting a representation of handwriting input as described above, the UI 1000 presents typeface text corresponding to letters identified from handwriting input that has been received, furthermore, in such an example embodiment, a user may edit the typeface text to thus alter the input being provided and hence e.g. a parameter to be searched. E.g., upon presentation of the text 1002, a user may instead decide that rather than e.g. the weather for Tokyo, the user wishes to know the weather for Toronto. In such an instance, the user may e.g. position a cursor at the end of the word to delete the last three characters and resume providing input to correspond to Toronto, or otherwise perform an edit from Tokyo to Toronto.

For instance, the user may strike through the text 1002 (e.g., using their linger or a stylus, the user may contact the display at the text 1002 and draw horizontally through it) which, after e.g. a threshold time following the strikethrough may cause the word Tokyo to disappear and leave a blank version of the UI 1000 for providing input thereto. As another example, a user may shake or gyrate the device itself which presents the UI 500, which would be detected by an accelerometer of the device and be recognized by the device as input to remove the text 1002 and render a blank version of the UI 1000 for providing different input thereto. But in any case, once an intended parameter has been provided, a confirm selector element 1004 maybe selected, which responsive thereto causes the device to launch a corresponding application and provide the parameter thereto for execution of a search or other function in accordance with present principles.

Continuing the detailed description in reference to FIG. 11, it shows yet another example handwriting space UI 1100 which includes an area 1101 presenting input that has been received (e.g. handwriting of the word “Tokyo”) and also additional area 1102 such as e.g. beneath the representation for entrance of additional input should the user intend to enter input that e.g. will not fit if written left to right owing to display dimensions, and/or for input that comprises more than one word. Notwithstanding, note that in some embodiments (e.g. based on configurations set by a user) the additional area 1102 may instead be for providing input thereto for executing a different function (e.g. a different search) at the same time as a search for information on “Tokyo”. Thus, it is to be understood that in some embodiments an application may be launched and plural searches may be automatically executed based on input received to the UI 1100.

Accordingly and also in example embodiments, selector elements 1104 and 1106 may be presented. The element 1104 may he selectable to configure the device to perform different and/or separate searches in accordance with present principles based on input received at the area 1101 of the UI 1100 where the representation “Tokyo” is presented and based on input received at the area 1102. The element 1106 may be selectable to configure the device to perform a single search comprising data and/or parameters corresponding to input entered to both areas 1101 and 1102.

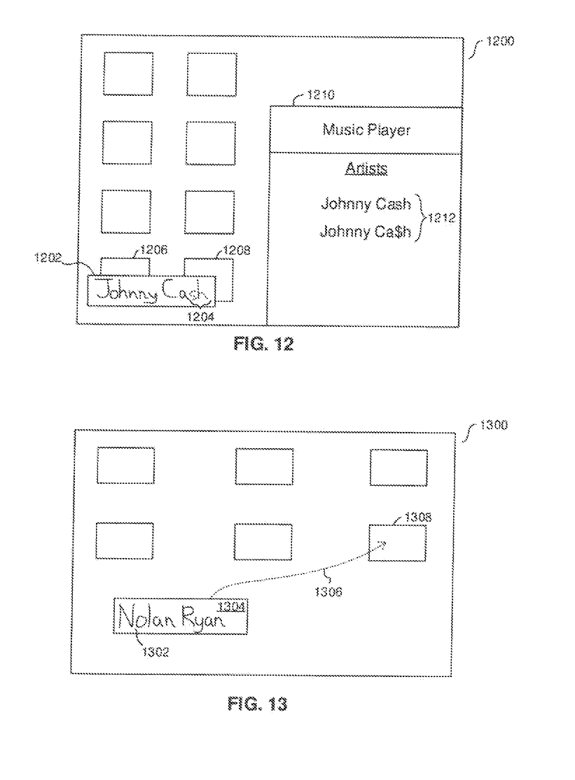

Now in reference to FIG. 12, another example home screen UI 1200 is shown, and presented thereon is a handwriting space UI 1202. As may be appreciated from the UI 1202, handwriting input “Johnny Ca” has been represented thereon, and perforated representations 1204 of handwriting of the letters “s” and “h” which have been input by a user but not yet represented on the UI 1202 are also shown. It may be appreciated that four letters (“h”, “n”, “n”, and “y”) have been in whole or in part directed to an area of the UI 1200 that prior to presentation of the UI 1202 was presenting an icon 1206 ( which is still partially shown in FIG. 12). It may also be appreciated that only the letter “h” has been input to an area of the UI 1200 that prior to presentation of the UI 1202 was presenting an icon 1208. Thus, in such an example embodiment a device presenting the UI 1200 may determine that a greater amount of the input has been provided to an area of the UI 1200 including the icon 1206 than an area of the UI including the icon 1208, and hence an application to initiate in accordance with present principles is a music player application associated with the icon 1206. Accordingly, a UI 1210 for the music player application has been presented upon initiation of the music player application.

Also, it may be appreciated that while the music player application has been launched, the UI 1210 presented, and data corresponding to the letters “Johnny Ca” have been provided to the music player application, additional input is still being received and data has not yet been provided to the music player application corresponding to the letters “sh”. Accordingly, the music player application has launched and a search has been executed on the search parameter “Johnny Ca” thus rendering two possible results 1212 including an artist named “Johnny Cash” and an artist named “Johnny Ca$h”. It is to be understood that once data corresponding to the letters “sh” is also be provided to the music player application, the search results may then be further narrowed to “Johnny Cash” and exclude “Johnny Ca$h”.

Furthermore, it is to be understood that in an embodiment such as is shown in FIG. 12, even after an application has been launched, the same area to which the input was received may still fee used to execute other functions (e.g. searches) using that application after launch even if e.g. the UI associated with the application is presented elsewhere. In other words, e.g. the same “search area” of the display may be used to keep providing input e.g. in the “foreground” while the application is being launched in background and/or in another area of the display, as well as even after the application has been launched and a UI presented so that additional searches may be executed and/or corrections to the first search may be made at the area to which the input was directed.

Moving on, reference is now made to FIG. 13. FIG. 13 shows another UI for providing input to a device to then automatically launch an application and execute a function based on the input in accordance with present principles. A home screen UI 1300 is shown. Input indicating “Nolan Ryan” has been received by the device, causing a representation 1302 of the input to be presented on a handwriting space UI 1304. However, in this instance a user has pro vided the input to an area of the home screen UI 1300 not presenting an area associated with an application other than the home screen application. In such an instance, the device may he configured to, after receipt of the input corresponding to representation 1302, receive input represented by tracing 1306 which may be a line, arrow, and/or tracing from at or near (e.g. within a threshold distance of) the UI 1304 to an icon 1308 which is associated with an application the user desires to launch and have the input “Nolan Ryan” e.g. converted into data for use as a search parameter to perform a search using the application associated with the icon 1308.

Note that although FIG. 13 has been described above in reference to input first being provided and then a line drawn to the icon of an application to launch and perform a search based on the input, it is to be understood that in other embodiments a line, arrow, etc. may first be drawn from at or near an icon to an area of the UI 1300 not presenting an icon or area associated with an application oilier than the home screen application, and responsive to the input ceasing at a particular “open” area a handwriting space UI may be automatically presented for providing input thereto.

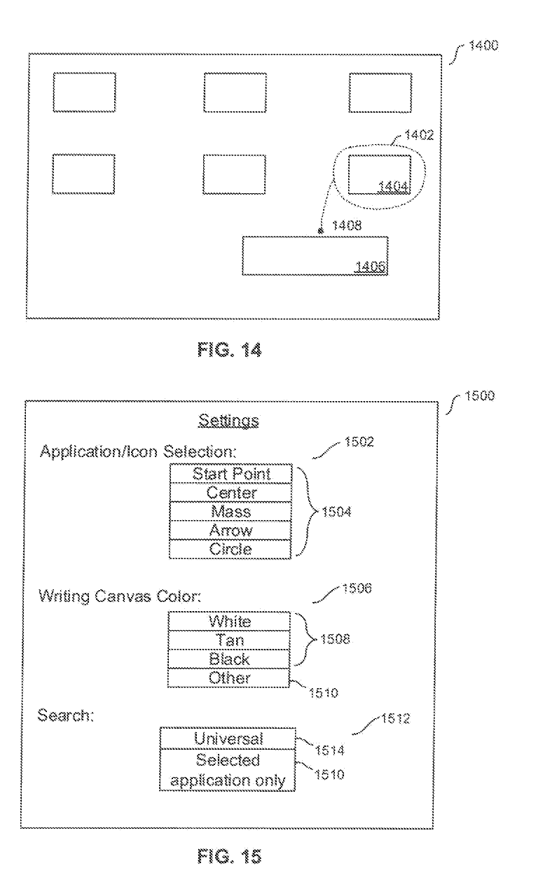

FIG. 14 shows an example of this, save for rather than an arrow or line originating from an icon being used, a circle 1402 has been drawn around an icon 1404 presented on a home screen UI 1400. A handwriting space UI 1406 has been automatically presented adjacent to a point 1408 at which continuous contact of a user and/or stylus of drawing the circle 1402 and continuing into an “open” space of the UI 1400 has ceased. A user may thus provide input to the UI 1406 upon its presentation to use to subsequently e.g. provide input and automatically launch an application associated with the icon 1404 and perform a search based on the input to the UI 1406.

Reference is now made to FIG. 15, which shows a UI 1500 for configuring settings of a device and/or software undertaking present principles. The UI 1500 includes a first setting 1502 for a user to select a way to select an application to which to direct input provided to a home screen UI and/or touch-enabled display in accordance with present principles. Thus, respective selector elements 1504 are shown that are respectively selectable to automatically without further user input use a stalling point (e.g. beginning) of input, a point, corresponding to a center portion of input, a “mass” portion of input (e.g. an icon to which more input has been directed than to another icon(s)), an arrow (e.g. such as described above in reference to FIG. 13), or a circle (e.g. such as described above in reference to FIG. 14).

A second setting 1506 is also shown on the UI 1500. The setting 1506 pertains to a color in which to present a handwriting space UI in accordance with present principles (e.g., a “background” color). Respective selector elements 1508 are thus provided for respectively selecting the colors white, tan, or black as a color in which to present a handwriting space UI. A selector element 1510 is also shown, which is selectable to e.g. cause another UI to be presented and/or overlaid on the UI 1500 for selecting still other colors besides white, tan, and black.

The UI 1500 also includes a third setting 1512 for selecting a type of search to be executed in accordance with present principles. E.g., upon providing input to be used tor a search, a search for information based on the input only using a particular identified application may be performed (e.g. based on selection of the selector element 1516). Nonetheless, in addition to search results using and/or based on the identified application, a user may also wish to have more “universal” search results presented concurrently, such as a search of the entire device presenting the UI 1500 and/or an Internet search using one or more parameters corresponding to input that has been received. A selector element 1514 has thus been provided for selection should a universal search be the user's preference.

Though not shown for simplicity, it is to be understood that still other settings may be included in the UI 1500, such as those described above in reference to other figures, even though not specifically shown in example FIG. 15.

Without reference to any particular figure, it is to be understood based on the foregoing that present principles provide for e.g. launching an application and providing search term at the same time. For example, a search term may be provided in handwriting for e.g. a song a user wants to hear, and receipt of the search term also launches a music application. The input may be e.g. received and/or processed by a launcher and/or desktop application which may then launch the other application (e.g. the one the user wants to launch) and provide the input and/or associated data thereto. In some embodiments, the input may be provided to a widget running on the desktop screen.

Furthermore, in some embodiments such as e.g. where a user wishes to write on an icon that is presented near an edge of the display where there may not be enough room to comfortably write all of the input the user wishes to provide, a line and arrow may be drawn by the user from the icon to an “empty” space of the home screen where e.g. another icon or widget is not presented and the input may then be provided. Alternatively, the user may first provide the input to such empty space and then draw an arrow to, circle, or otherwise select the icon the user wishes to launch. As another example, an icon may first have a circle drawn around it and then a line emanating therefrom may then he drawn to an empty space where the user wishes to write.

As yet another example, e.g. in some embodiments a user may provide a magnification command to magnify an area of the display which e.g. presents and icon and/or where the user wants to provide handwriting input for e.g. executing a search and then upon magnification the input may provided fey the user and received by the device. E.g., using eye tracking software and a camera, a device in accordance with present principles may detect where a user is looking and automatically magnify that area and even present a handwriting space UI thereon.

Additionally, as indicated above, in some embodiments where e.g. a search is the function to execute in response to handwriting input to an icon and/or home screen area, the search may be for e.g. “universal” search results (e.g. Internet and/or web search results) in addition to a “local” search which may be a context-relevant search based on the application to be launched. Also, in some embodiments, if a user writes to an empty area of a home screen UI (e.g. and does not draw an arrow to an icon to launch an associated application as described above), a universal search may be performed whereas writing directed to a particular icon and/or area and hence a particular application may instead cause a local search to be performed. Search results for such a “universal” search of e.g. contents and/or data anywhere in the device may be presented as a list containing links to all applications, media, contacts, documents, etc. applicable to the universal search and/or determined to be relevant to it. A user may then select any item in the list and the relevant application, file, etc. may he automatically opened in response. What's more, if desired a user may (e.g. using a settings UI) configure whether to execute both universal and local searches when input to or otherwise associated with an icon is provided, and furthermore if both are to be used, a user may specify particular limitations on the “universal” search such as search engine used and/or types of searches to perform.

Still without reference to any particular figure, it is to be understood that should a user err and provide unintended and/or erroneous input, the user may e.g. strikethrough or slash the representation of the handwriting as presented and/or strikethrough the area where the user entered at least a portion of the input, which may in response cause the device to stop the process (e.g. not launch the associated application or if already launched, not provide data and/or search parameters thereto based on the input). In embodiments where a representation of the handwriting input is presented (and/or where typeset text corresponding to handwriting input is presented), a user may also be permitted to edit portions thereof (e.g. manipulating a cursor to a particular position in the representation, providing a delete command, and then handwriting in one or more characters into the space).

Also without reference to any particular figure, if a user wishes to search more than one thing (e.g. different searches based on different parameters) by providing handwriting input in accordance with present principles, a threshold time between input may be used to identify first and second input and perform different searches accordingly. In addition to or in lieu of the foregoing, multiple lines of input may be entered, where each line may be recognized by the device as a different search parameter for separate searches.

It may now be appreciated that present principles provide for allowing the user to select an application while providing search data in a single action. A desktop and/or home screen may contain areas associated with different applications (and/or e.g. functions) such as maps, weather, music, and/or searching. With a stylus or finger, the user may write directly on top of an application area. For example, the user might write ‘tokyo’ over the ‘map’ area or the ‘weather’ area. When the user stops writing, the application “beneath” the writing is launched, the writing is converted to text, and the text is given to the application for processing e.g. in a way that may be specific to the application. For example, the map application will open a map of Tokyo. The weather application will show the weather in Tokyo.

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a carrier wave and/or a signal per se.

While the particular INITIATING APPLICATION AND PERFORMING FUNCTION BASED ON INPUT is herein shown and described in detail, it is to be understood that the subject matter which is encompassed by the present application is limited only by the claims.

What is claimed is:

1. A first device, comprising:
a processor;
a touch-enabled display accessible to the processor; and
a memory accessible to the processor and bearing instructions executable by the processor to:
receive first input to the touch-enabled display at an area of the touch-enabled display which presents at least partially thereat an icon associated with a first application; and
in response to receipt of the first input, initiate the first application and execute a search at least in part using the first application, the search being executed at least in part based on the first input.

2. The first device of claim 1, wherein the instructions are further executable to:
determine that the first input is handwriting input;
identify at least one parameter based on the handwriting input; and
use the parameter to execute the search.

3. The first device of claim 1, wherein the icon is a first icon, and wherein the instructions are executable to:
in response to receipt of the first input, determine that the first application is an application to initiate, initiate the first application, and execute the search, wherein the determination that the first application is an application to initiate is at least in part based on identification of the first input as being directed to at least a portion of the touch-enabled display which presents the first icon and identification of none of the first input being directed to at least a portion of the touch-enabled display which presents a second icon different from the first icon.

4. The first device of claim 1, wherein the icon is a first icon, and wherein the instructions are executable to:
in response to receipt of the first input, determine that the first application is an application to initiate, initiate the first application, and execute the search, wherein the determination that the first application is an application to initiate is at least in part based on identification of a first amount of the first input which is directed to a first portion of the area which presents the first icon being greater than a second amount of the first input which is directed to a second portion of the area which presents a second icon different from the first icon.

5. The first device of claim 1, wherein the instructions are executable to:
in response to receipt of the first input, determine that the first application is an application to initiate, initiate the first application, and execute the search, wherein the determination that the first application is an application to initiate is at least in part based on identification of a beginning of the first input as being directed to at least a portion of the touch-enabled display which presents the icon.

6. The first device of claim 1, wherein the first input is directed to a user interface (UI) presented on the touch-enabled display, wherein the UI presents plural icons, the UI having a second application associated therewith which when executed is used to present the UI on the touch-enabled display, which is used to process the first input to initiate the first application, and which is used to provides data associated with the first input to the first application for execution of the search at least in part using the first application.

7. The first device of claim 1, wherein the instructions are further executable to:
in response to receipt of a threshold amount of the first input to a portion of the area, present a user interface (UI) at least at the portion of the area, wherein the UI upon presentation comprises a representation of at least a first portion of the first input which satisfied the threshold amount.

8. The first device of claim 7, wherein the instructions are further executable to:
in response to receipt of a second portion of the first input beyond the first portion, expand the UI beyond the portion of the area.

9. The first device of claim 1, wherein the instructions are executable to:
in response to receipt of the first input determine that the first application is a map application, initiate the first application, convert the first input to location data for execution of the search, and provide the location data to the first application for execution of the search based at least in part on the location data.

10. The first device of claim 1, wherein the instructions are executable to:
in response to receipt of the first input, determine that the first application is a weather application, initiate the first application, convert the first input to location data for execution of the search, and provide the location data to the first application for execution of the search based at least in part on the location data.

11. The first device of claim 1, wherein the instructions are executable to:
in response to receipt of the first input, determine that the first application is a music player application, initiate the first, application, convert the first input to data which pertains to at least one of a song name, album name, and artist name for execution of the search, and provide the data to the first application for execution of the search based at least in pan on the data.

12. The first device of claim 1, wherein the instructions are executable to:
in response to receipt of the first input, determine that the first application is an Internet search application, initiate the first application, convert the first input to text, and provide the text to the first application for execution of the search based at least in part on the text.

13. The first device of claim 1, wherein the area is a first area, and wherein the instructions are further executable by the processor to:
receive second input to the touch-enabled display at a second area of the touch-enabled display which dons not present at least partially thereat an icon; and
in response to receipt of the second input and without presenting a window at the second area, execute a search for data based on the second input that is at least one of accessible over a network and stored at the first device.

14. A method, comprising:
receiving at least a portion of first input to a user interface (UI) presented on a touch-enabled display at an area of the UI associated with a first application that is different from a second application which is used to present the UI; and
in response to receiving the first input, launching the first application and providing data pertaining to the first input to the first application for performing a function at least in part using the data, wherein the function is a function that would not otherwise be performed upon launching the application without additional input from a user subsequent to launch.

15. The method of claim 14, wherein the function is a search for information using the first application.

16. The method of claim 14, further comprising:
subsequent to receiving the first input, determining that no additional input has been received for a threshold time; and
in response to receiving the first input and in response to determining that no additional input has been received for the threshold time, launching the first application and providing the data pertaining to the first input to the first application for performing the function at least in part using the data.

17. A computer readable storage medium that is not a carrier wave, the computer readable storage medium comprising instructions executable by a processor to:
receive at least a portion of first input to a touch-enabled display accessible to the processor at a portion of the touch-enabled display associated with an application; and
in response to receipt of the first input, initiate the application and provide data pertaining to the first input to the application for performance of a function at least in part using the data.

18. The computer readable storage medium of claim 17, wherein the function is a function that would not otherwise be performed upon initiation of the application without additional input from a user subsequent to initiation.

19. The computer readable storage medium of claim 17, wherein the instructions are further executable to:
in response to receipt of the first input, determine that the first input is input other than, relative to a plane established by a face of the touch-enabled display on which images are presentable, laterally unmoving touch input, initiate the application, and provide fee data to the application for performance of the function at least in part using the data.

20. The computer readable storage medium of claim 17, wherein the function is a search for information using the application.
